(19) United States
(12) Patent Application Publication
(10) Pub. No.: US 2019/0217861 A1
(43) Pub. Date: Jul. 18, 2019

(54) TRAVEL CONTROL DEVICE AND TRAVEL CONTROL METHOD

(71) Applicant: HONDA MOTOR CO., LTD., Tokyo (JP)

(72) Inventor: Yukinori KURAHASHI, WAKO-SHI (JP)

(21) Appl. No.: 16/248,142

(22) Filed: Jan. 15, 2019

(30) Foreign Application Priority Data
Jan. 17, 2018 (JP) 2018-005567

(51) Int. Cl. B60W 30/16; B60W 30/165; B60W 30/18; G05D 1/02; G08G 1/16

(52) U.S. Cl. CPC B60W 30/162; B60W 30/165; B60W 30/18163; G05D 1/0223; B60W 2550/308; G08G 1/166; B60W 2720/106; B60W 2550/302; G05D 1/0234

(57) ABSTRACT

When a nearby vehicle detecting unit detects a plurality of nearby vehicles, a vehicle controlling unit sets a temporary target vehicle speed or temporary target acceleration or deceleration with respect to each of the plurality of nearby vehicles by using the target degree of approach such as a target inter-vehicle distance. The vehicle controlling unit selects, as a target vehicle speed or target acceleration or deceleration, a value which suppresses approach to the nearby vehicles most significantly among the values of the temporary target vehicle speed or the temporary target acceleration or deceleration. The vehicle controlling unit controls the acceleration or deceleration of the host vehicle based on the target vehicle speed or the target acceleration or deceleration.

### CROSS-REFERENCE TO RELATED APPLICATION

This application is based upon and claims the benefit of priority from Japanese Patent Application No. 2018-005567 filed on Jan. 17, 2018, the contents of which are incorporated herein by reference.

### BACKGROUND OF THE INVENTION

### Field of the Invention:

The present invention relates to a travel control device and a travel control method that make a host vehicle travel behind a vehicle ahead based on the target degree of approach such as a set inter-vehicle distance.

### Description of the Related Art:

An object of Japanese Laid-Open Patent Publication No. 11-321379 is to provide a vehicle travel control device that makes it possible for a host vehicle to travel more safely by generating an alarm or changing the details of travel control, for example, in the event of a cutting-in vehicle while the vehicle travel control device performs control to make the host vehicle travel with an inter-vehicle distance kept constant ([0008], Abstract of the Disclosure). Moreover, another object of Japanese Laid-Open Patent Publication No. 11-321379 is to provide the vehicle travel control device that makes it possible for the host vehicle to travel with an inter-vehicle distance kept constant by determining whether or not another vehicle is a cutting-in vehicle by using the host vehicle location and the location of the other vehicle in a travel lane and controlling the host vehicle speed in accordance with the determination result ([0009]).

To attain the above objects, in Japanese Laid-Open Patent Publication No. 11-321379 (Abstract of the Disclosure), a cutting-in vehicle detecting section 101 and a details-of-control changing section 103 are provided. The cutting-in vehicle detecting section 101 detects a cutting-in vehicle that cuts in front of a host vehicle traveling behind a vehicle ahead by using a camera having a wider field of view than a radar 105. The details-of-control changing section 103 changes the details of host vehicle speed control when the cutting-in vehicle is detected.

Moreover, the cutting-in vehicle detecting section 101 detects and tracks a vehicle that passes the host vehicle by image processing and determines whether or not the vehicle is a cutting-in vehicle based on the host vehicle speed and the host vehicle location and the passing vehicle location. When the cutting-in vehicle is detected, the cutting-in vehicle detecting section 101 outputs a cutting-in vehicle detection flag Fc and a cutting-in vehicle speed Vc (Abstract of the Disclosure).

When the cutting-in vehicle is detected, the details-of-control changing section 103 makes a judgment as to whether to make the host vehicle travel while keeping the speed thereof at the time of detection (FIG. 5), the host vehicle travel at a speed lower than the host vehicle speed (FIG. 6), or the host vehicle travel at the host vehicle speed or the cutting-in vehicle speed, whichever is lower (FIG. 7) and generates a speed command Vcop (Abstract of the Disclosure). The details-of-control changing section 103 determines which processing is selected by comparing a host vehicle speed Vo with first and second threshold values Vth1 and Vth2 (FIGS. 8, [0052] to [0054]).

The first and second threshold values Vth1 and Vth2 are set in view of target traveling conditions which are to be attained by traveling control and the specific values thereof are not limited to particular values. Moreover, a case of Vth1=100 km/h and Vth2=60 km/h is described as an example ([0054]).

### SUMMARY OF THE INVENTION

As described above, in Japanese Laid-Open Patent Publication No. 11-321379, when the cutting-in vehicle is detected, a judgment as to whether to make the host vehicle travel while keeping the speed thereof at the time of detection (FIG. 5), the host vehicle travel at a speed lower than the host vehicle speed (FIG. 6), or the host vehicle travel at the host vehicle speed or the cutting-in vehicle speed, whichever is lower (FIG. 7) is made, and the speed command Vcop is generated (Abstract of the Disclosure). A determination on which processing is selected is made by a comparison of the host vehicle speed Vo with the first and second threshold values Vth1 and Vth2 (FIGS. 8, [0052] to [0054]). As the first and second threshold values Vth1 and Vth2, a case of Vth1=100 km/h and Vth2=60 km/h is described as an example ([0054]).

For example, when the host vehicle travels at the host vehicle speed or the cutting-in vehicle speed, whichever is lower (FIG. 7, 903 of FIG. 8), if the host vehicle speed is higher than the cutting-in vehicle speed, the host vehicle speed is adjusted so as to conform to the cutting-in vehicle speed. In that case, the inter-vehicle distance between the host vehicle and the cutting-in vehicle stops changing. This causes a state in which the host vehicle and the cutting-in vehicle are close to each other to continue, which may cause a driver of the host vehicle to feel uncomfortable.

The present invention has been made in view of the above-described circumstances and an object thereof is to provide a travel control device and a travel control method, the device and the method that can suitably control the acceleration or deceleration of a host vehicle.

A travel control device according to the present invention is a travel control device including: a target degree-of-approach setting unit that sets the target degree of approach to a nearby vehicle detected by a nearby vehicle detecting unit; and a vehicle controlling unit that controls, based on the target degree of approach, a host vehicle to follow a vehicle ahead as the nearby vehicle detected by the nearby vehicle detecting unit. When the nearby vehicle detecting unit detects a plurality of the nearby vehicles, the vehicle controlling unit sets a temporary target vehicle speed or temporary target acceleration or deceleration with respect to each of the plurality of the nearby vehicles by using the target degree of approach, selects, as a target vehicle speed or target acceleration or deceleration, a value which suppresses approach to the nearby vehicle most significantly among the values of the temporary target vehicle speed or the temporary target acceleration or deceleration, and controls the acceleration or deceleration of the host vehicle based on the target vehicle speed or the target acceleration or deceleration.

According to the present invention, when the nearby vehicles are a plurality of vehicles ahead, the acceleration or deceleration of the host vehicle is controlled based on a value which suppresses approach to the nearby vehicle most significantly among the values of the temporary target vehicle speed or the temporary target acceleration or deceleration with respect to each of the plurality of vehicles ahead. For instance, when deceleration is needed in relation to each of the plurality of vehicles ahead, the host vehicle is decelerated based on a value at which the deceleration is the largest. Moreover, when acceleration is needed in relation to each of the plurality of vehicles ahead, the host vehicle is accelerated based on a value at which the acceleration is the smallest. As a result, when a plurality of vehicles are travelling ahead the host vehicle, it is possible to control the acceleration or deceleration of the host vehicle suitably.

When the nearby vehicles are a plurality of vehicles behind, the acceleration or deceleration of the host vehicle is controlled based on a value which suppresses approach to the nearby vehicle most significantly among the values of the temporary target vehicle speed or the temporary target acceleration or deceleration with respect to each of the vehicles behind. For example, when the host vehicle approaches each of the plurality of vehicles behind by the deceleration of the host vehicle, the host vehicle is decelerated based on a value at which the deceleration is the smallest. As a result, when a plurality of vehicles are travelling behind the host vehicle, it is possible to control the acceleration or deceleration of the host vehicle suitably.

As the target degree of approach, a target inter-vehicle distance or target time-to-collision (TTC), for instance, can be used.

When a second vehicle ahead having been traveling in an adjacent lane is making a lane change from the adjacent lane to a travel lane of the host vehicle toward an area between a first vehicle ahead traveling in the travel lane of the host vehicle, while the host vehicle is in follow-on traveling behind the first vehicle ahead, the vehicle controlling unit may continue a comparison between the values of the temporary target vehicle speed or the temporary target acceleration or deceleration with respect to the first vehicle ahead and the second vehicle ahead until the second vehicle ahead has completed a lane change. This makes it possible to appropriately deal with a case where there is the second vehicle ahead making a lane change from the adjacent lane to the travel lane of the host vehicle. Moreover, even when the first vehicle ahead decelerates while the second vehicle ahead is making a lane change, it is possible to control the acceleration or deceleration of the host vehicle with respect to the first vehicle ahead.

The vehicle controlling unit may change the temporary target vehicle speed or the temporary target acceleration or deceleration so that the host vehicle is prevented from approaching closer to the nearby vehicle as the offset distance between the host vehicle and the nearby vehicle in the width direction of a road is short. The shorter the offset distance, the higher a possibility that the nearby vehicle traveling in the adjacent lane adjacent to the travel lane of the host vehicle moves to the travel lane of the host vehicle; the longer the offset distance, the lower a possibility that the nearby vehicle is moving into the travel lane of the host vehicle. Therefore, by changing the temporary target vehicle speed or the temporary target acceleration or deceleration so that the host vehicle is prevented from approaching closer to the nearby vehicle as the offset distance is reduced, it is possible to set the target vehicle speed or the target acceleration or deceleration appropriate to the state of the nearby vehicle. For instance, a long offset distance reduces the necessity to prevent the host vehicle from approaching closer to the nearby vehicle. Thus, by avoiding unnecessary variations in speed, it is possible to improve merchantability.

The vehicle controlling unit may make a displaying unit display icons of the plurality of the nearby vehicles as the target with respect to which the temporary target vehicle speed or the temporary target acceleration or deceleration is to be set. The vehicle controlling unit may monitor whether or not an exclusion command, by which any one of the plurality of the nearby vehicles as the target is excluded from the target, is input to an operating unit by a vehicle occupant. Furthermore, the vehicle controlling unit may exclude the nearby vehicle designated by the exclusion command input via the operating unit, from the target.

As a result, in a case where the travel control device regards as the target but the vehicle occupant does not, the nearby vehicle can be excluded from the target. This makes it possible to set the temporary target vehicle speed or the temporary target acceleration or deceleration with respect to each nearby vehicle in accordance with the senses of the vehicle occupant.

When the nearby vehicle detecting unit detects the vehicle ahead and a vehicle behind, the vehicle controlling unit may use the temporary target vehicle speed or the temporary target acceleration or deceleration which is set with respect to the vehicle ahead by giving higher priority thereto than the temporary target vehicle speed or the temporary target acceleration or deceleration which is set with respect to the vehicle behind. As a result, even when the vehicle ahead is slower than the host vehicle and the vehicle behind is faster than the host vehicle, the temporary target vehicle speed or the temporary target acceleration or deceleration which is set with respect to the vehicle ahead is preferentially used. This makes it possible to accelerate or decelerate the host vehicle in accordance with a vehicle occupant's perception.

A travel control method according to the present invention is a method including: a nearby vehicle detecting step of detecting a nearby vehicle in surrounding areas of a host vehicle; a target degree-of-approach setting step of setting the target degree of approach to the nearby vehicle; and a vehicle controlling step of making, based on the target degree of approach, the host vehicle travel behind a vehicle ahead as the nearby vehicle detected in the nearby vehicle detecting step. When a plurality of the nearby vehicles are detected in the nearby vehicle detecting step, in the vehicle controlling step, a temporary target vehicle speed or temporary target acceleration or deceleration with respect to each of the plurality of the nearby vehicles is set by using the target degree of approach, a value of the values of the temporary target vehicle speed or the temporary target acceleration or deceleration, the value which suppresses approach to the nearby vehicle most significantly is selected as a target vehicle speed or target acceleration or deceleration, and the acceleration or deceleration of the host vehicle is controlled based on the target vehicle speed or the target acceleration or deceleration.

According to the present invention, it is possible to control the acceleration or deceleration of the host vehicle suitably.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram depicting the schematic configuration of a vehicle including a travel control device according to a first embodiment of the present invention;

FIG. 2 is a diagram depicting sections of a computation unit of the travel control device of the first embodiment;

FIG. 3A is a diagram depicting a situation in which a nearby vehicle (hereinafter referred to as the “first vehicle ahead”) is traveling ahead of a host vehicle in the first embodiment, FIG. 3B is a diagram depicting a situation in which a nearby vehicle (hereinafter referred to as the “second vehicle ahead”) is making a lane change from an adjacent lane to a host vehicle lane toward an area in front of the host vehicle in the first embodiment, and FIG. 3C is a diagram depicting a situation in which the first vehicle ahead of FIG. 3A is slowing down abruptly and the second vehicle ahead of FIG. 3B is making a lane change;

FIG. 4A is a timing diagram showing the target acceleration or deceleration of the host vehicle with respect to the first vehicle ahead in the situation of FIG. 3A, FIG. 4B is a timing diagram showing the target acceleration or deceleration of the host vehicle with respect to the second vehicle ahead in the situation of FIG. 3B, and FIG. 4C is a timing diagram showing the temporary target acceleration or deceleration of the host vehicle, which is calculated in relation to the first vehicle ahead, the temporary target acceleration or deceleration of the host vehicle, which is calculated in relation to the second vehicle ahead, and the target acceleration or deceleration of the host vehicle, which is set based on the above temporary target acceleration or deceleration, in the situation of FIG. 3C;

FIG. 5 is a flowchart of adaptive cruise control (hereinafter referred to as “ACC”) in the first embodiment;

FIG. 6 is a flowchart (the details of S15 of FIG. 5) for calculating the temporary target acceleration or deceleration with respect to each nearby vehicle in the first embodiment;

FIG. 7 is a flowchart of ACC in a second embodiment;

FIG. 8 is a flowchart (the details of S54 of FIG. 7) of exclusion processing in the second embodiment;

FIG. 9 is a flowchart (the details of S56 of FIG. 7) for calculating the temporary target acceleration or deceleration with respect to each nearby vehicle in the second embodiment;

FIG. 10 is a diagram depicting a situation in which a plurality of nearby vehicles are traveling ahead of the host vehicle in the second embodiment;

FIG. 11 is a diagram depicting a situation in which one nearby vehicle is traveling ahead of the host vehicle and one nearby vehicle is traveling behind the host vehicle in a third embodiment; and

FIG. 12 is a flowchart of ACC in the third embodiment.

### DESCRIPTION OF THE PREFERRED EMBODIMENTS

### A. First Embodiment

### <A-1. Configuration>

### [A-1-1. Overall Configuration]

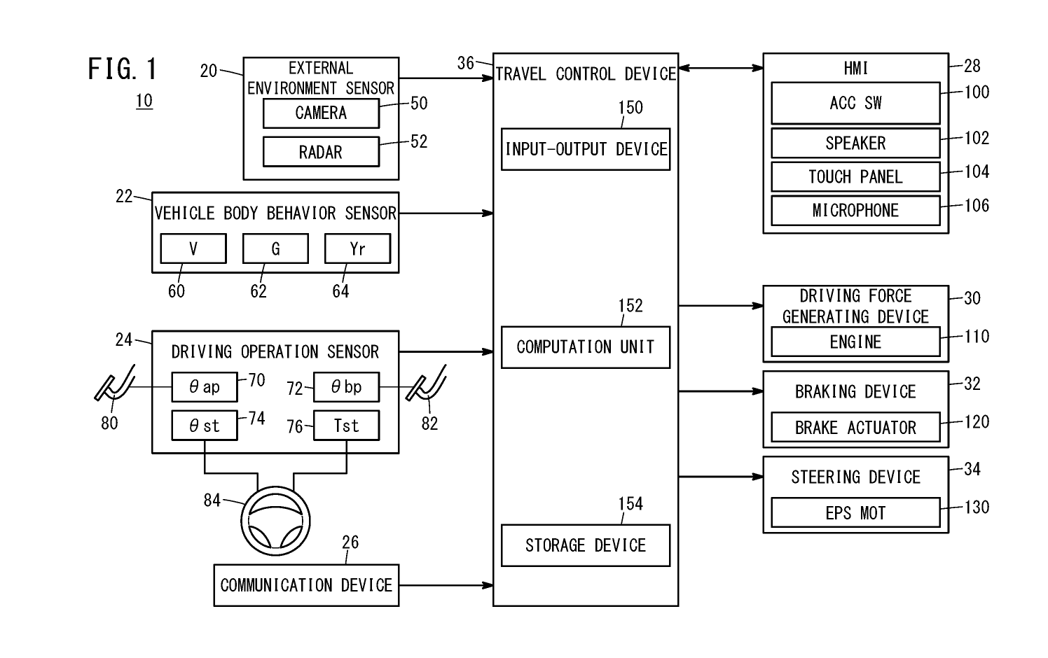

FIG. 1 is a block diagram depicting the schematic configuration of a vehicle 10 including a travel control device 36 (hereinafter also referred to as the “control device 36”) according to a first embodiment of the present invention. The vehicle 10 (hereinafter also referred to as the “host vehicle 10”) includes, in addition to the control device 36, an external environment sensor 20, a vehicle body behavior sensor 22, a driving operation sensor 24, a communication device 26, a human machine interface 28 (hereinafter referred to as the “HMI 28”), a driving force generating device 30, a braking device 32, and a steering device 34.

### [A-1-2. External Environment Sensor 20]

The external environment sensor 20 (a nearby vehicle detecting unit) detects information on the external environment of the vehicle 10 (hereinafter also referred to as the “external environment information Ie”). The external environment sensor 20 includes a plurality of vehicle exterior cameras 50 (an imaging section) and a plurality of radars 52. It is to be noted that one vehicle exterior camera 50 and one radar 52 are depicted in FIG. 1.

The plurality of vehicle exterior cameras 50 (hereinafter also referred to as the “cameras 50”) output image information Iimage on surrounding area images Fs obtained by taking images of the surrounding areas (an area ahead of the vehicle 10, areas on the sides of the vehicle 10, and an area behind the vehicle 10) of the vehicle 10. The plurality of radars 52 output radar information Iradar indicating the reflected waves for the electromagnetic waves radiated to the surrounding areas (an area ahead of the vehicle 10, an area ahead of the vehicle 10 on the left, an area ahead of the vehicle 10 on the right, an area behind the vehicle 10 on the left, and an area behind the vehicle 10 on the right) of the vehicle 10. In addition to the cameras 50 and the radars 52, light detection and ranging (LIDAR) may be provided. LIDAR emits laser in all directions from the vehicle 10 in a continuous manner, measures the three-dimensional position of a reflecting point based on the reflected waves, and outputs the three-dimensional position as three-dimensional information.

[A-1-3. Vehicle Body Behavior Sensor 22]

The vehicle body behavior sensor 22 detects information (vehicle behavior information Ib) on the behavior of the vehicle 10 (in particular, the vehicle body). The vehicle body behavior sensor 22 includes a vehicle speed sensor 60, an acceleration sensor 62, and a yaw rate sensor 64. The vehicle speed sensor 60 detects the vehicle speed V [km/h] and the direction of travel of the vehicle 10. The acceleration sensor 62 detects the acceleration G [m/s²] of the vehicle 10. The acceleration G includes longitudinal acceleration a, lateral acceleration Glat, and vertical acceleration Gv (the acceleration G may be acceleration in one direction). The yaw rate sensor 64 detects the yaw rate Yr [rad/s] of the vehicle 10.

### [A-1-4. Driving Operation Sensor 24]

The driving operation sensor 24 detects information (driving operation information Ido) on a driving operation which is performed by a driver. The driving operation sensor 24 includes an acceleration pedal sensor 70, a brake pedal sensor 72, a steering angle sensor 74, and a steering torque sensor 76. The acceleration pedal sensor 70 detects the amount of operation θap [%] of an acceleration pedal 80. The brake pedal sensor 72 detects the amount of operation θbp [%] of a brake pedal 82. The steering angle sensor 74 detects the steering angle θst [deg] of a steering wheel 84. The steering torque sensor 76 detects torque Tst [N·m] applied to the steering wheel 84.

### [A-1-5. Communication Device 26]

The communication device 26 performs wireless communication with external devices. The external devices here include, for example, an unillustrated external server. Examples of the communication device 26 of the first embodiment include a communication device that is installed in the vehicle 10 (or fixed to the vehicle 10 at all times); alternatively, the communication device 26 may be, for example, a communication device that can be carried around outside the vehicle 10, such as a mobile telephone or a smartphone.

### [A-1-6. HMI 28]

The HMI 28 (a destination inputting section) accepts an operation input from a vehicle occupant and presents various kinds of information to the vehicle occupant in visual, audible, and tactual ways. The HMI 28 includes an ACC switch 100 (hereinafter also referred to as the “ACC SW 100”), a speaker 102, a touch panel 104, and a microphone 106.

The ACC SW 100 is a switch for issuing, by an operation which is performed by the vehicle occupant, commands to start and end adaptive cruise control (ACC) and specify a set vehicle speed Vset. Moreover, in addition to or in place of the ACC SW 100, a command to start or end ACC or specify the set vehicle speed Vset can also be issued by other methods (such as voice input via the microphone 106). The touch panel 104 includes, for example, a liquid crystal panel or an organic EL panel.

### [A-1-7. Driving Force Generating Device 30]

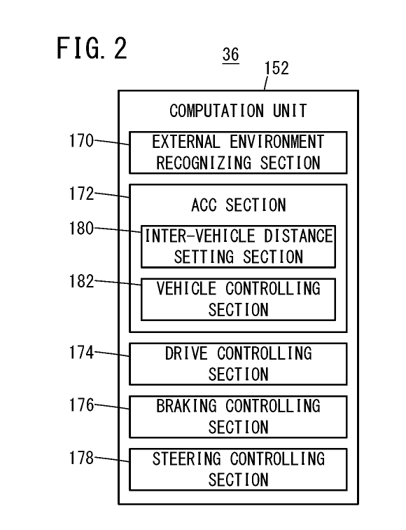

The driving force generating device 30 includes an engine 110 as a traveling drive source and generates a traveling driving force of the vehicle 10. The traveling drive source may be provided as a drive motor or the like. The driving force generating device 30 is controlled by a drive controlling section 174 (FIG. 2) of the travel control device 36.

### [A-1-8. Braking Device 32]

The braking device 32 includes a brake actuator 120 (or a hydraulic mechanism), a brake pad, and so forth and generates a braking force of the vehicle 10. The braking device 32 may be a device that controls any one of an engine brake configured with the engine 110 and a regeneration brake configured with the drive motor or both. The braking device 32 is controlled by a braking controlling section 176 (FIG. 2) of the travel control device 36.

### [A-1-9. Steering Device 34]

The steering device 34 includes an electric power steering (EPS) motor 130 and so forth and controls the steering angle θst. The steering device 34 is controlled by a steering controlling section 178 (FIG. 2) of the travel control device 36.

### [A-1-10. Travel Control Device 36]

### (A-1-10-1. General Outline of the Travel Control Device 36)

When the driver performs a driving operation without driving assistance such as ACC, the travel control device 36 controls the driving force generating device 30, the braking device 32, and the steering device 34 based on the detected values from the vehicle body behavior sensor 22 and the driving operation sensor 24. Moreover, when the driver turns on the ACC switch 100 and performs a driving operation with ACC, the travel control device 36 controls the driving force generating device 30 and the braking device 32 based on the detected values of the external environment sensor 20 in addition to the vehicle body behavior sensor 22 and the driving operation sensor 24.

As depicted in FIG. 1, the travel control device 36 includes an input-output device 150, a computation unit 152, and a storage device 154. The input-output device 150 handles input and output to and from the devices (the sensors 20, 22, and 24, for example) other than the travel control device 36.

The computation unit 152 includes a central processing unit (CPU) and performs computations based on signals from the sensors 20, 22, and 24, the communication device 26, the HMI 28, and so forth. Then, the computation unit 152 generates, based on the computation results, signals to be transmitted to the communication device 26, the HMI 28, the driving force generating device 30, the braking device 32, and the steering device 34. The details of the computation unit 152 will be described later.

The storage device 154 stores a program and data which are used by the computation unit 152. The storage device 154 includes, for example, random-access memory (hereinafter referred to as the “RAM”). As the RAM, volatile memory such as a register and nonvolatile memory such as flash memory can be used. Moreover, in addition to the RAM, the storage device 154 may include read-only memory (ROM).

### (A-1-10-2. Computation Unit 152)

FIG. 2 is diagram depicting sections of the computation unit 152 of the travel control device 36 of the first embodiment. As depicted in FIG. 2, the computation unit 152 of the travel control device 36 includes an external environment recognizing section 170, an adaptive cruise control section 172 (hereinafter also referred to as the “ACC section 172”), the drive controlling section 174, the braking controlling section 176, and the steering controlling section 178.

In FIG. 2, one computation unit 152 includes a plurality of sections; instead, the input-output device 150, the computation unit 152, and the storage device 154 may be provided for each of the sections included in the computation unit 152. In other words, an electronic control unit (ECU) may be provided for each of the sections included in the computation unit 152.

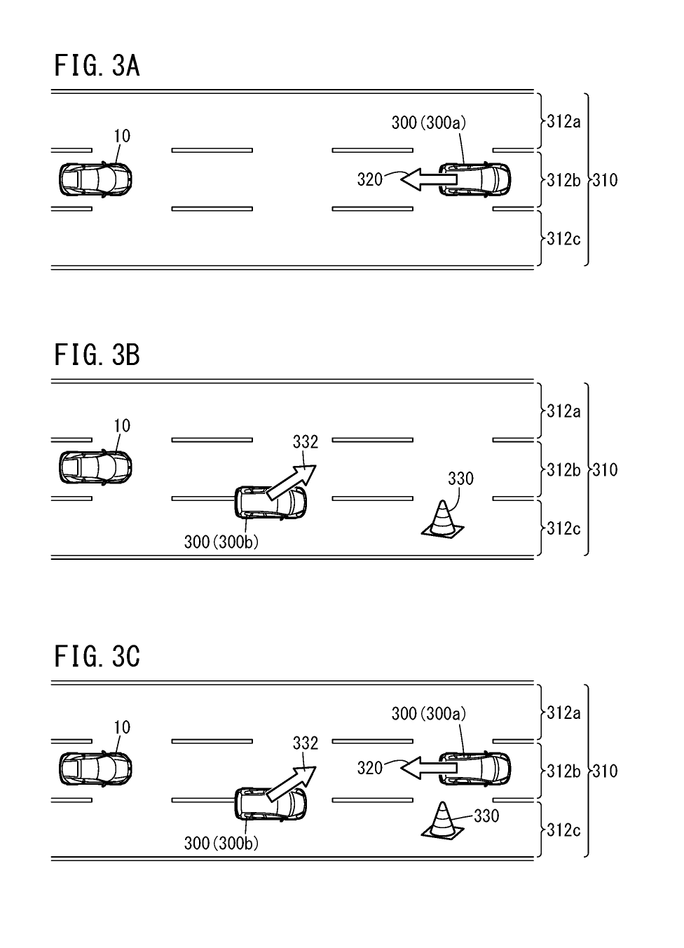

The external environment recognizing section 170 (a lane recognizing section) recognizes obstacles and a driving lane (or a lane mark) around the host vehicle 10 based on the external environment information Ie (in particular, the surrounding area images Fs) from the external environment sensor 20. The obstacles here include, for instance, nearby vehicles 300 (vehicles ahead 300a and 300b and the like) of FIGS. 3A to 3C, a pedestrian, a bicycle, a wall, and a utility pole.

The ACC section 172 executes ACC. When a vehicle ahead is not present within a predetermined range in front of the host vehicle 10, ACC controls the acceleration or deceleration of the host vehicle 10 by using a fixed vehicle speed as a target vehicle speed Vtar. When a vehicle ahead is present within the predetermined range in front of the host vehicle 10, ACC controls the acceleration or deceleration of the host vehicle 10 in such a way as to keep a target inter-vehicle distance Dtar between the host vehicle 10 and the vehicle ahead in accordance with the vehicle speed V. When controlling the acceleration or deceleration of the host vehicle 10, ACC controls the driving force generating device 30 and the braking device 32 via the drive controlling section 174 and the braking controlling section 176.

As depicted in FIG. 2, the ACC section 172 includes an inter-vehicle distance setting section 180 and a vehicle controlling section 182. The inter-vehicle distance setting section 180 (a target degree-of-approach setting unit) sets the target inter-vehicle distance Dtar (the target degree of approach) between the host vehicle 10 and the nearby vehicle 300. Based on the target inter-vehicle distance Dtar, the vehicle controlling section 182 makes the host vehicle 10 travel behind the vehicle ahead 300a or the like detected by the external environment recognizing section 170.

The drive controlling section 174 adjusts the traveling driving force of the vehicle 10 by controlling the engine 110 based on the amount of operation θap of the acceleration pedal 80 or a command from another section of the travel control device 36. The braking controlling section 176 controls the braking force of the vehicle 10 by actuating the brake actuator 120 or the like based on the amount of operation θbp of the brake pedal 82 or a command from another section of the travel control device 36.

The steering controlling section 178 (a steering control device) controls the steering angle θst or steering of the vehicle 10 by controlling the EPS motor 130 in accordance with an operation of the steering wheel 84 which is performed by the driver or a command from another section of the travel control device 36.

### <A-2. ACC of the First Embodiment>

### [A-2-1. General Outline of ACC]

Next, ACC of the first embodiment will be described. As described above, ACC controls the host vehicle 10 to follow the vehicle ahead 300a or the like detected by the external environment recognizing section 170 based on the target inter-vehicle distance Dtar.

FIG. 3A is a diagram depicting a situation in which a nearby vehicle 300 (hereinafter also referred to as the “first vehicle ahead 300a” or the “vehicle ahead 300a”) is traveling ahead of the host vehicle 10 in the first embodiment. A road 310 on which the host vehicle 10 and the first vehicle 300a are traveling has three lanes each way, which has three lanes 312a, 312b, and 312c. In the following description, the lane 312b is also referred to as a host vehicle lane 312b or a travel lane 312b and the lanes 312a and 312c are also referred to as adjacent lanes 312a and 312c.

The first vehicle 300a is traveling ahead in the lane 312b in which the host vehicle 10 is traveling. In FIG. 3A, an arrow 320 attached to the vehicle ahead 300a indicates that the vehicle ahead 300a is slowing down.

FIG. 3B is a diagram depicting a situation in which a nearby vehicle 300 (hereinafter also referred to as the “second vehicle ahead 300b” or the “vehicle ahead 300b”) is making a lane change from the adjacent lane 312c to the host vehicle lane 312b toward an area in front of the host vehicle 10 in the first embodiment. The second vehicle 300b travelling ahead is making a lane change to the host vehicle lane 312b because of an obstacle 330 in the adjacent lane 312c (the travel lane of the second vehicle ahead 300b). In FIG. 3B, an arrow 332 drawn on the vehicle ahead 300b indicates that the vehicle ahead 300b is making a lane change.

FIG. 3C is a diagram depicting a situation in which the first vehicle ahead 300a of FIG. 3A is slowing down abruptly and the second vehicle ahead 300b of FIG. 3B is making a lane change.

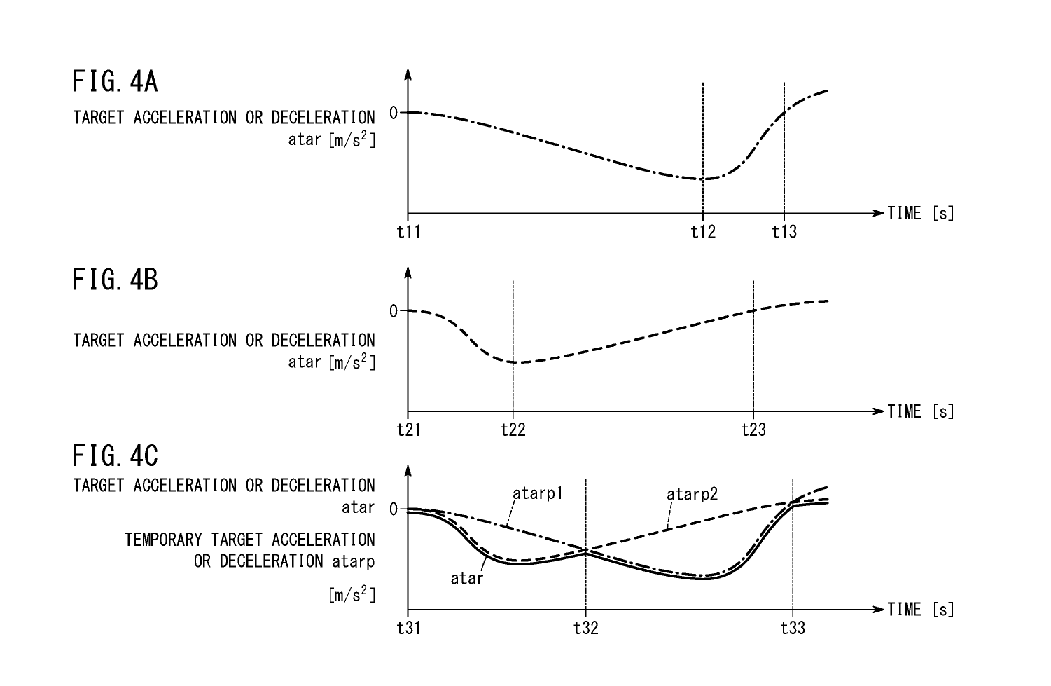

FIG. 4A is a timing chart showing the target acceleration or deceleration atar of the host vehicle 10 with respect to the first vehicle ahead 300a in the situation of FIG. 3A. As is clear from FIG. 4A, the target acceleration or deceleration atar of the host vehicle 10 is a negative value from time point t11 to time point t13, which indicates deceleration. The smallest target acceleration or deceleration atar is observed at time point t12.

FIG. 4B is a timing diagram showing the target acceleration or deceleration atar of the host vehicle 10 with respect to the second vehicle ahead 300b in the situation of FIG. 3B. As is clear from FIG. 4B, the target acceleration or deceleration atar of the host vehicle 10 is a negative value from time point t21 to time point t23, which indicates deceleration. The smallest target acceleration or deceleration atar is observed at time point t22.

FIG. 4C is a timing diagram showing the temporary target acceleration or deceleration atarp (atarp1) of the host vehicle 10, which is calculated in relation to the first vehicle ahead 300a, the temporary target acceleration or deceleration atarp (atarp2) of the host vehicle 10, which is calculated in relation to the second vehicle ahead 300b, and the target acceleration or deceleration atar of the host vehicle 10, which is set based on the temporary target acceleration or deceleration atarp1 and the temporary target acceleration or deceleration atarp2, in the situation of FIG. 3C.

The temporary target acceleration or deceleration atarp1 is the same as the target acceleration or deceleration atar of FIG. 4A, and the temporary target acceleration or deceleration atarp2 is the same as the target acceleration or deceleration atar of FIG. 4B. The target acceleration or deceleration atar of FIG. 4C is set as the value of the temporary target acceleration or deceleration atarp1 or the value of the temporary target acceleration or deceleration atarp2, whichever is smaller.

That is, from time point t31 to time point t32, the temporary target acceleration or deceleration atarp2 is smaller than the temporary target acceleration or deceleration atarp1. For this reason, from time point t31 to time point t32, the temporary target acceleration or deceleration atarp2 is used as the target acceleration or deceleration atar. At time point t32, the temporary target acceleration or deceleration atarp1 and the temporary target acceleration or deceleration atarp2 become equal to each other. From time point t32 to time point t33, the temporary target acceleration or deceleration atarp1 is smaller than the temporary target acceleration or deceleration atarp2. For this reason, from time point t32 to time point t33, the temporary target acceleration or deceleration atarp1 is used as the target acceleration or deceleration atar. By selecting a smaller value in this manner, it is possible to select a value which most significantly suppresses approach to the vehicles 300a and 300b travelling ahead.

### [A-2-2. Flow of ACC]

### (A-2-2-1. Overall Flow of ACC)

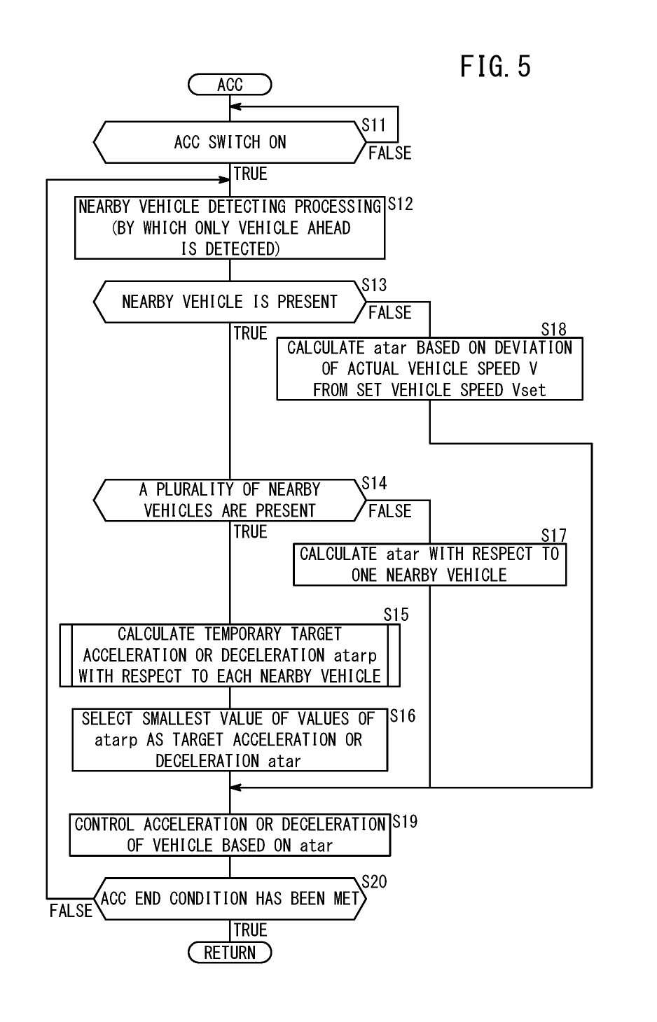

FIG. 5 is a flowchart of ACC in the first embodiment. In step S11, the ACC section 172 determines whether or not the ACC switch 100 has been turned on. If the ACC switch 100 has been turned on (S11: TRUE), the procedure proceeds to step S12. If the ACC switch 100 is OFF (S11: FALSE), step S11 is repeated.

In step S12, the external environment recognizing section 170 executes nearby vehicle detecting processing by which a nearby vehicle 300 which is present in the surrounding areas of the host vehicle 10 is detected. In the nearby vehicle detecting processing of the first embodiment, an object to be detected is only a vehicle ahead which is present ahead of the host vehicle 10 (the first vehicle ahead 300a of FIG. 3A, the second vehicle ahead 300b of FIG. 3B, or the like). Therefore, a vehicle behind which is present behind the host vehicle 10 is not an object to be detected. However, as in a third embodiment, it is also possible to set the vehicle behind as an object to be detected.

Moreover, the vehicle ahead is limited to a nearby vehicle 300 which is moving in the direction in which the host vehicle 10 is moving; furthermore, the vehicle ahead is limited to a nearby vehicle 300 which is present in the travel lane 312b in which the host vehicle 10 is present or the adjacent lanes 312a and 312c adjacent to the travel lane 312b.

In step S13, the ACC section 172 determines whether or not a nearby vehicle 300 is present based on the result of the nearby vehicle detecting processing executed by the external environment recognizing section 170. If a nearby vehicle 300 is present (S13: TRUE), in step S14, the ACC section 172 determines whether or not a plurality of nearby vehicles 300 are present. If a plurality of nearby vehicles 300 are present (S14: TRUE), the procedure proceeds to step S15.

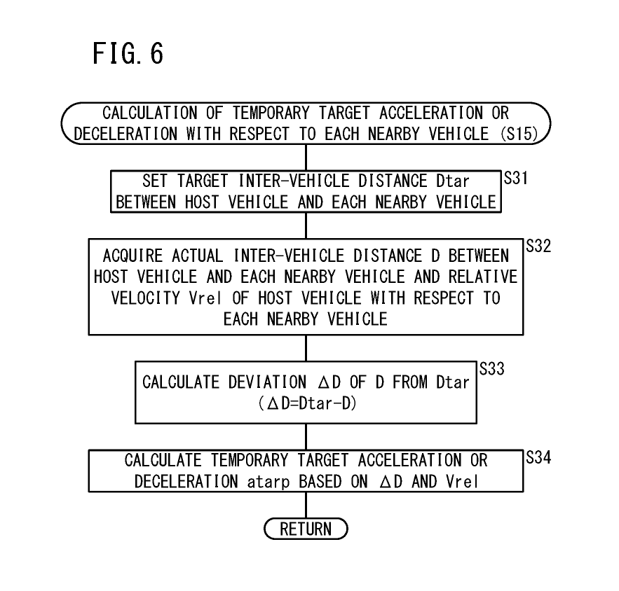

In step S15, the ACC section 172 calculates the temporary target acceleration or deceleration atarp with respect to each nearby vehicle 300. The details of the calculation of the temporary target acceleration or deceleration atarp will be described later with reference to FIG. 6. In step S16, the ACC section 172 selects the slowest value of the values of the temporary target acceleration or deceleration atarp as the target acceleration or deceleration atar.

Back to step S14, if there are not a plurality of nearby vehicles 300 (S14: FALSE), in step S17, the ACC section 172 calculates the target acceleration or deceleration atar with respect to one nearby vehicle 300. Back in step S13, if a nearby vehicle 300 is not present (S13: FALSE), the procedure proceeds to step S18. In step S18, the ACC section 172 calculates the target acceleration or deceleration atar based on a deviation of the vehicle speed V (hereinafter also referred to as the “actual vehicle speed V”) detected by the vehicle speed sensor 60 from the set vehicle speed Vset input via the ACC switch 100.

In step S19, the ACC section 172 controls the acceleration or deceleration of the vehicle 10 based on the target acceleration or deceleration atar selected or calculated in step S16, S17, or S18. For instance, the ACC section 172 calculates a deviation Δa of the longitudinal acceleration a detected by the acceleration sensor 62 from the target acceleration or deceleration atar. If the deviation Δa is positive, the ACC section 172 increases the longitudinal acceleration a of the vehicle 10 via the driving force generating device 30. If the deviation Aa is negative, the ACC section 172 reduces the longitudinal acceleration a (or increases the deceleration) of the vehicle 10 via any one of the driving force generating device 30 and the braking device 32 or both. To reduce the longitudinal acceleration a, for example, the output of the engine 110 is reduced or the engine brake is actuated. In addition to or in place of this, it is also possible to reduce the longitudinal acceleration a by actuating the braking device 32.

In step S20, the ACC section 172 determines whether or not an ACC end condition, which is a condition for ending ACC, has been met. As the ACC end condition, for example, turning off of the ACC switch 100 is used. If the ACC end condition has not been met (S20: FALSE), the procedure goes back to step S12. If the ACC end condition has been met (S20: TRUE), this processing is ended.

(A-2-2-2. Calculation of the Temporary Target Acceleration or Deceleration Atarp with Respect to each Nearby Vehicle 300 (S15 of FIG. 5))

FIG. 6 is a flowchart (the details of S15 of FIG. 5) for calculating the temporary target acceleration or deceleration atarp with respect to each nearby vehicle 300 in the first embodiment. In step S31, the ACC section 172 sets the target inter-vehicle distance Dtar between the host vehicle 10 and each nearby vehicle 300. For example, the ACC section 172 sets the target inter-vehicle distance Dtar in accordance with the vehicle speed V of the host vehicle 10. Specifically, the ACC section 172 sets the target inter-vehicle distance Dtar so that the higher the vehicle speed V, the longer the target inter-vehicle distance Dtar; the lower the vehicle speed V, the shorter the target inter-vehicle distance Dtar.

When the target inter-vehicle distance Dtar is set based on the vehicle speed V of the host vehicle 10, the values of the target inter-vehicle distances Dtar set with respect to the nearby vehicles 300 are the same. Alternatively, the target inter-vehicle distance Dtar may be changed depending on the lane, the host vehicle lane 312b or the adjacent lanes 312a and 312c, in which the nearby vehicle 300 is present.

In step S32, the ACC section 172 acquires, from the external environment recognizing section 170, the actual inter-vehicle distance D between the host vehicle 10 and each nearby vehicle 300 and the relative velocity Vre1 of the host vehicle 10 with respect to each nearby vehicle 300. As for the relative velocity Vre1, a direction in which the host vehicle 10 approaches the nearby vehicle 300 is assumed to be positive and a direction in which the host vehicle 10 moves away from the nearby vehicle 300 is assumed to be negative. In step S33, the ACC section 172 calculates a deviation ΔD of the actual inter-vehicle distance D from the target inter-vehicle distance Dtar (ΔD=Dtar−D).

In step S34, the ACC section 172 calculates the temporary target acceleration or deceleration atarp based on the deviation ΔD (S33) and the relative velocity Vre1 (S32). Specifically, the ACC section 172 calculates the temporary target acceleration or deceleration atarp so that the larger the positive deviation AD, the larger the temporary target acceleration or deceleration atarp (the larger the acceleration). Moreover, the ACC section 172 calculates the temporary target acceleration or deceleration atarp so that the greater the absolute value of the negative deviation ΔD, the smaller the temporary target acceleration or deceleration atarp (the larger the deceleration).

Furthermore, the ACC section 172 calculates the temporary target acceleration or deceleration atarp so that the higher the relative velocity Vre1, the smaller the temporary target acceleration or deceleration atarp (the smaller the acceleration or the larger the deceleration). Moreover, the ACC section 172 calculates the temporary target acceleration or deceleration atarp so that the lower the relative velocity Vre1, the larger the temporary target acceleration or deceleration atarp (the larger the acceleration or the smaller the deceleration).

In the first embodiment, a map defining the relationship between a combination of the deviation ΔD and the relative velocity Vre1 and the temporary target acceleration or deceleration atarp is stored in the storage device 154 in advance. The ACC section 172 then reads the temporary target acceleration or deceleration atarp corresponding to a combination of the deviation ΔD and the relative velocity Vre1 from the map and uses the read temporary target acceleration or deceleration atarp.

### <A-3. Effects of the First Embodiment>

As described above, according to the first embodiment, the acceleration or deceleration of the host vehicle 10 is controlled based on the smallest value (that is, a value which suppresses approach to the vehicles ahead 300a and 300b most significantly) among the values of the temporary target acceleration or deceleration atarp with respect to the vehicles ahead 300a and 300b (FIG. 3C) (FIG. 4C, S16 of FIG. 5). For instance, when deceleration is needed in relation to each of the vehicles 300a and 300b travelling ahead, the host vehicle 10 is decelerated based on a value at which the deceleration is the largest. When acceleration is needed in relation to each of the vehicles 300a and 300b travelling ahead, the host vehicle 10 is accelerated based on a value at which the acceleration is the smallest. As a result, when the vehicles 300a and 300b are travelling ahead the host vehicle 10, it is possible to control the acceleration or deceleration of the host vehicle 10 suitably.

In the first embodiment, when the second vehicle ahead 300b traveling in the adjacent lane 312c is making a lane change from the adjacent lane 312c to the travel lane 312b of the host vehicle 10 toward an area between the first vehicle ahead 300a and the host vehicle 10 in follow-on traveling behind the first vehicle ahead 300a traveling in the travel lane 312b (FIG. 3C) of the host vehicle 10, the vehicle controlling section 182 (a vehicle controlling unit) continues a comparison between the temporary target acceleration or deceleration atarp calculated with respect to the first vehicle ahead 300a and the temporary target acceleration or deceleration atarp calculated with respect to the second vehicle ahead 300b while the second vehicle ahead 300b is making a lane change (repetition of S12 to S16, S19, and S20 of FIG. 5). This makes it possible to appropriately deal with a case where there is the second vehicle ahead 300b making a lane change from the adjacent lane 312c to the travel lane 312b of the host vehicle 10. Even when the first vehicle ahead 300a decelerates while the second vehicle ahead 300b is making a lane change (FIG. 3C), it is possible to control the acceleration or deceleration of the host vehicle 10 with respect to the first vehicle ahead 300a (FIG. 4C).

### B. Second Embodiment

<B-1. Configuration (A Difference from the First Embodiment)>

The configuration of a second embodiment is the same as the configuration of the first embodiment (FIG. 1). In the following description, the same component elements as those of the first embodiment will be identified with the same reference characters and the detailed explanations thereof will be omitted. A difference between the first embodiment and the second embodiment is the specifics of ACC.

### <B-2. ACC of the Second Embodiment>

### [B-2-1. General Outline of ACC]

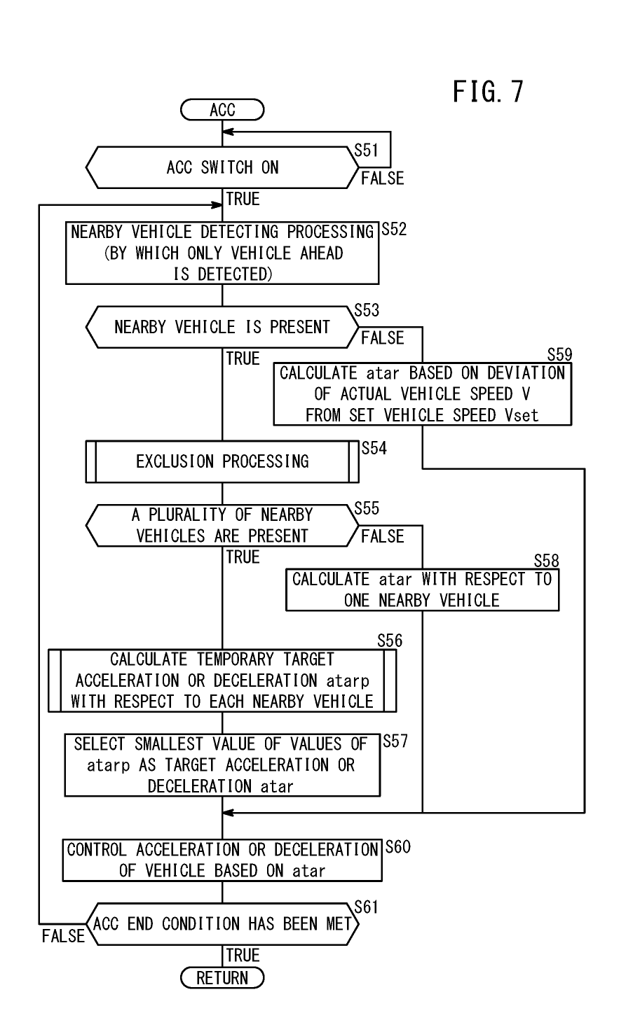

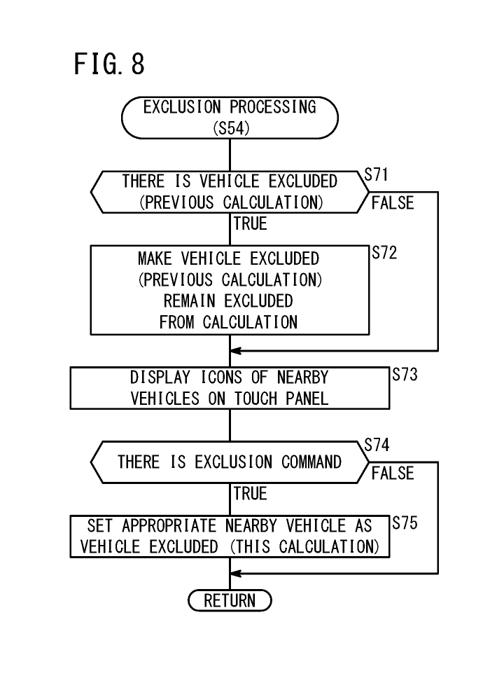

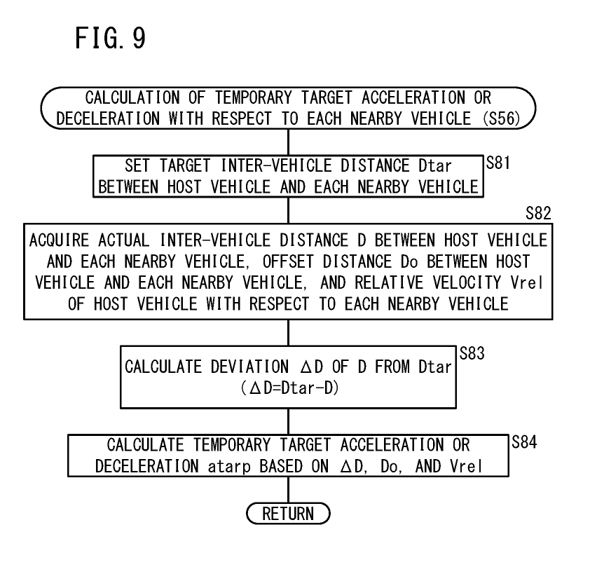

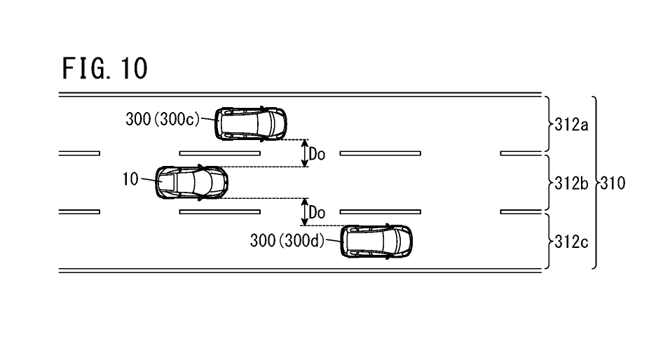

Next, ACC of the second embodiment will be described. In the first embodiment, ACC is performed by using the flows shown in FIGS. 5 and 6. On the other hand, in the second embodiment, ACC is performed by using flows shown in FIGS. 7 to 9. Specifically, in ACC of the second embodiment, exclusion processing is performed, the exclusion processing by which the nearby vehicle 300 recognized by the external environment recognizing section 170 is excluded from the calculation of the temporary target acceleration or deceleration atarp based on an instruction provided by a vehicle occupant (S54 of FIG. 7, FIG. 8). Moreover, in the calculation of the temporary target acceleration or deceleration atarp with respect to each nearby vehicle 300 (S56 of FIG. 7), an offset distance Do (FIG. 10) is used (S84 of FIG. 9).

### [B-2-2. Flow of ACC]

### (B-2-2-1. Overall Flow of ACC)

FIG. 7 is a flowchart of ACC in the second embodiment. Steps S51, S52, and S53 are the same as Steps S11, S12, and S13 of FIG. 5. In step S53, if a nearby vehicle 300 is present (S53: TRUE), the procedure proceeds to step S54.

In step S54, the ACC section 172 performs the exclusion processing by which the nearby vehicle 300 recognized by the external environment recognizing section 170 is excluded from the calculation of the temporary target acceleration or deceleration atarp based on an instruction provided by the vehicle occupant. The exclusion processing will be described later with reference to FIG. 8.

In step S55, the ACC section 172 determines whether or not a plurality of nearby vehicles 300 are present. In this case, the nearby vehicle 300 excluded from the target is not included. If a plurality of nearby vehicles 300 are present (S55: TRUE), the procedure proceeds to step S56.

In step S56, the ACC section 172 calculates the temporary target acceleration or deceleration atarp with respect to each nearby vehicle 300. The details of the calculation of the temporary target acceleration or deceleration atarp will be described with reference to FIG. 9. In step S57, the ACC section 172 selects the smallest value of the values of the temporary target acceleration or deceleration atarp as the target acceleration or deceleration atar.

Back in step S55, if there are not a plurality of nearby vehicles 300 (S55: FALSE), in step S58, the ACC section 172 calculates the target acceleration or deceleration atar with respect to one nearby vehicle 300. Steps S59, S60, and S61 are the same as Steps S18, S19, and S20 of FIG. 5.

### (B-2-2-2. Exclusion Processing)

FIG. 8 is a flowchart (the details of S54 of FIG. 7) of the exclusion processing in the second embodiment. In step

S71, the ACC section 172 determines whether or not there is a nearby vehicle 300 which has been excluded from the target by the vehicle occupant in the previous exclusion processing (hereinafter also referred to as the “vehicle 300ex excluded (previous calculation)”). A determination “true” (TRUE) is made in step S71 if the vehicle 300ex excluded is set in step S54 and the procedure goes back again to step S54 after a determination “false” (FALSE) is made in step S61, which will be described later.

If there is a vehicle 300ex excluded (previous calculation) (S71: TRUE), in step S72, the ACC section 172 keeps the vehicle 300ex excluded (previous calculation) from the target. Therefore, in this ACC (FIG. 7), among the nearby vehicles 300, which have been recognized by the external environment recognizing section 170 since the previous ACC, the vehicle 300ex excluded from the target is continuously treated as the vehicle 300ex excluded also in this exclusion processing. If there is not a vehicle 300ex excluded (previous calculation) (S71: FALSE) or after step S72, the procedure proceeds to step S73.

In step S73, the ACC section 172 displays icons (which are not depicted in the drawing) of the nearby vehicles 300 on the touch panel 104. On a screen (which is not depicted in the drawing) which is displayed on the touch panel 104, a plan view including, for example, an icon of the host vehicle 10 and icons of the nearby vehicles 300 is displayed. In this plan view, the icon of the host vehicle 10 and the icons of the nearby vehicles 300 are disposed so as to correspond to the locations of the host vehicle 10 and the nearby vehicles 300, respectively.

In step S74, the ACC section 172 determines whether or not there is an exclusion command given by the vehicle occupant for a particular nearby vehicle 300 of the nearby vehicles 300. The exclusion command is given by the vehicle occupant by touching the icon of the nearby vehicle 300 displayed on the touch panel 104, for example. If there is an exclusion command (S74: TRUE), the procedure proceeds to step S75.

In step S75, the ACC section 172 sets the nearby vehicle 300 designated by the exclusion command as a vehicle 300ex excluded (this calculation). The nearby vehicle 300 set as the vehicle 300ex excluded (this calculation) is excluded from the calculation of the temporary target acceleration or deceleration atarp in step S56 of FIG. 7. If there is no exclusion command (S74: FALSE) or when step S75 is ended, this exclusion processing is ended.

(B-2-2-3. Calculation of the Temporary Target Acceleration or Deceleration Atarp with Respect to each Nearby Vehicle 300 (S56 of FIG. 7))

FIG. 9 is a flowchart (the details of S56 of FIG. 7) for calculating the temporary target acceleration or deceleration atarp with respect to each nearby vehicle 300 in the second embodiment. In step S81, the ACC section 172 sets the target inter-vehicle distance Dtar between the host vehicle 10 and each nearby vehicle 300. step S81 is the same as step S31 of FIG. 6.

In step S82, the ACC section 172 acquires, from the external environment recognizing section 170, the actual inter-vehicle distance D between the host vehicle 10 and each nearby vehicle 300, the offset distance Do between the host vehicle 10 and each nearby vehicle 300, and the relative velocity Vre1 of the host vehicle 10 with respect to each nearby vehicle 300. The actual inter-vehicle distance D and the relative velocity Vre1 are the same as those in step S32 of FIG. 6.

FIG. 10 is a diagram depicting a situation in which a plurality of nearby vehicles 300 (hereinafter also referred to as the “third and fourth vehicles ahead 300c and 300d” or the “vehicles ahead 300c and 300d”) are traveling ahead of the host vehicle 10 in the second embodiment. In FIG. 10, the vehicle 300c is traveling ahead in the adjacent lane 312a on the left side adjacent to the travel lane 312b of the host vehicle 10 and the vehicle 300d is traveling ahead in the adjacent lane 312c on the right side adjacent to the travel lane 312b of the host vehicle 10.

Moreover, in FIG. 10, the offset distance Do which is used in the second embodiment is indicated. In the second embodiment, the external environment recognizing section 170 (FIG. 2) calculates the offset distance Do by using the external environment information Ie from the external environment sensor 20 (FIG. 1). The offset distance Do is the distance between a side face of the host vehicle 10 and a side face of the nearby vehicle 300, which faces the side face of the host vehicle 10, in the width direction of the road 310 (the vertical direction of FIG. 10). For instance, the offset distance Do between the host vehicle 10 and the vehicle 300c travelling ahead is the distance between the left side face of the host vehicle 10 and the right side face of the vehicle ahead 300c. The offset distance Do between the host vehicle 10 and the vehicle 300d travelling ahead is the distance between the right side face of the host vehicle 10 and the left side face of the vehicle 300d travelling ahead.

The offset distance Do is used to determine the degree of approach of the host vehicle 10 to the nearby vehicle 300 in the width direction of the road 310. Therefore, the offset distance Do may be defined by definitions other than the definition described above. For example, the distance between the center positions of the host vehicle 10 and the nearby vehicle 300 in the width direction of the road 310 may be defined as the offset distance Do.

In step S83, the ACC section 172 calculates a deviation ΔD of the actual inter-vehicle distance D from the target inter-vehicle distance Dtar (ΔD=Dtar−D).

In step S84, the ACC section 172 calculates the temporary target acceleration or deceleration atarp based on the deviation ΔD (S83), the offset distance Do (S82), and the relative velocity Vre1 (S82). Specifically, the ACC section 172 calculates the temporary target acceleration or deceleration atarp so that the smaller the deviation ΔD, the smaller the temporary target acceleration or deceleration atarp (the smaller the acceleration or the larger the deceleration). Moreover, the ACC section 172 calculates the temporary target acceleration or deceleration atarp so that the larger the deviation ΔD, the larger the temporary target acceleration or deceleration atarp (the larger the acceleration or the smaller the deceleration).

Furthermore, the ACC section 172 calculates the temporary target acceleration or deceleration atarp so that the shorter the offset distance Do, the smaller the temporary target acceleration or deceleration atarp (the smaller the acceleration or the larger the deceleration). In addition, the ACC section 172 calculates the temporary target acceleration or deceleration atarp so that the longer the offset distance Do, the larger the temporary target acceleration or deceleration atarp (the larger the acceleration or the smaller the deceleration).

Moreover, the ACC section 172 calculates the temporary target acceleration or deceleration atarp so that the higher the relative velocity Vre1, the greater the absolute value of the temporary target acceleration or deceleration atarp. In addition, the ACC section 172 calculates the temporary target acceleration or deceleration atarp so that the lower the relative velocity Vre1, the smaller the absolute value of the temporary target acceleration or deceleration atarp.

In the second embodiment, a map defining the relationship between a combination of the deviation ΔD, the offset distance Do, and the relative velocity Vre1 and the temporary target acceleration or deceleration atarp is stored in the storage device 154 in advance. The ACC section 172 then reads the temporary target acceleration or deceleration atarp corresponding to a combination of the deviation ΔD, the offset distance Do, and the relative velocity Vre1 from the map and uses the read temporary target acceleration or deceleration atarp.

### <B-3. Effects of the Second Embodiment>

According to the above-described second embodiment, in addition to or in place of the effects of the first embodiment, the following effects can be obtained. According to the second embodiment, the vehicle controlling section 182 (the vehicle controlling unit) (FIG. 2) changes the temporary target acceleration or deceleration atarp so that the host vehicle 10 is prevented from approaching closer to the nearby vehicle 300 as the offset distance Do (FIG. 10) between the host vehicle 10 and the nearby vehicle 300 in the width direction of the road 310 is reduced (S84 of FIG. 9). The shorter the offset distance Do, the higher a possibility that the nearby vehicle 300 traveling in the adjacent lane 312a or 312c adjacent to the travel lane 312b of the host vehicle 10 moves to the travel lane 312b of the host vehicle 10; the longer the offset distance Do, the lower a possibility that the nearby vehicle 300 moves to the travel lane 312b of the host vehicle 10. Therefore, by changing the temporary target acceleration or deceleration atarp so that the host vehicle 10 is prevented from approaching closer to the nearby vehicle 300 as the offset distance Do is reduced, it is possible to set the target acceleration or deceleration atar appropriate to the state of the nearby vehicle 300. For instance, a long offset distance Do reduces the necessity to prevent the host vehicle 10 from approaching closer to the nearby vehicle 300. Thus, by avoiding unnecessary variations in speed, it is possible to improve merchantability.

In the second embodiment, the vehicle controlling section 182 (the vehicle controlling unit) makes the touch panel 104 (a displaying unit) display icons of a plurality of nearby vehicles 300 which are objects with respect to which the temporary target acceleration or deceleration atarp is to be set (S73 of FIG. 8). The vehicle controlling section 182 monitors whether or not an exclusion command, by which any one of the plurality of nearby vehicles 300 is excluded from the target, is input to the touch panel 104 (an operating unit) by the vehicle occupant (S74 of FIG. 8). The vehicle controlling section 182 excludes the nearby vehicle 300, with respect to which the exclusion command is input via the touch panel 104, from the target (S75).

As a result, a nearby vehicle 300, which has been regarded as the target by the travel control device 36 but not by the vehicle occupant, can be excluded from the setting. This makes it possible to set the temporary target acceleration or deceleration atarp with respect to each nearby vehicle 300 in accordance with the senses of the vehicle occupant.

### C. Third Embodiment

<C-1. Configuration (A Difference from the First Embodiment)>

The configuration of a third embodiment is the same as the configuration of the first embodiment (FIG. 1). In the following description, the same component elements as those of the first embodiment will be identified with the same reference characters and detailed explanations thereof will be omitted. A difference between the first embodiment and the third embodiment is the specifics of ACC.

### <C-2. ACC of the Third Embodiment>

### [C-2-1. General Outline of ACC]

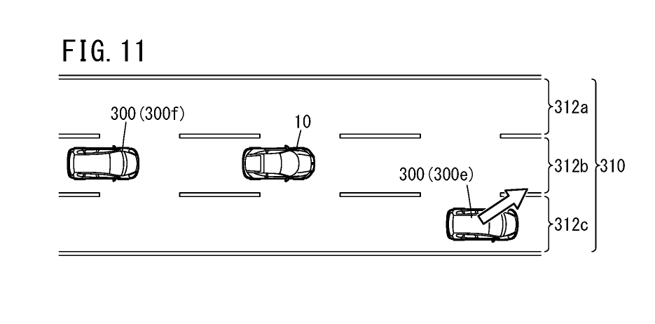

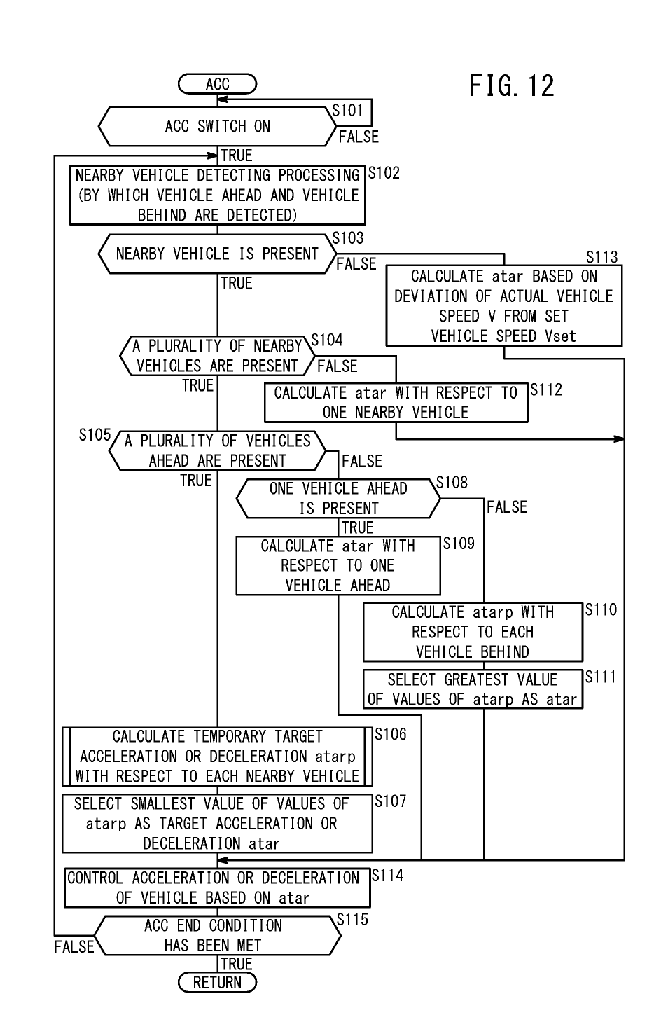

FIG. 11 is a diagram depicting a situation in which one nearby vehicle 300 (hereinafter also referred to as the “fifth vehicle ahead 300e” or the “vehicle ahead 300e”) is traveling ahead of the host vehicle 10 and one nearby vehicle 300 (hereinafter also referred to as the “vehicle behind 300f”) is traveling behind the host vehicle 10 in the third embodiment. In the first embodiment, ACC is performed by using the flows shown in FIGS. 5 and 6. Moreover, in the second embodiment, ACC is performed by using the flows shown in FIGS. 7 to 9. On the other hand, in ACC of the third embodiment, ACC is performed by using a flow shown in FIG. 12.

Specifically, while ACC of the first and second embodiments is performed only on the vehicles ahead 300a to 300d (S12 of FIGS. 5 and S52 of FIG. 7), ACC of the third embodiment is performed not only on the vehicle 300e travelling ahead, but also on the vehicle behind 300f.

### [C-2-2. Flow of ACC]

FIG. 12 is a flowchart of ACC in the third embodiment. In step S101, the ACC section 172 determines whether or not the ACC switch 100 has been turned on. If the ACC switch 100 has been turned on (S101: TRUE), the procedure proceeds to step S102. If the ACC switch 100 is OFF (S101: FALSE), step S101 is repeated.

In step S102, the external environment recognizing section 170 executes nearby vehicle detecting processing by which a nearby vehicle 300 which is present in the surrounding areas of the host vehicle 10 is detected. In the nearby vehicle detecting processing of the first and second embodiments, only a vehicle ahead which is present ahead of the host vehicle 10 (the first vehicle ahead 300a of FIG. 3A, the second vehicle ahead 300b of FIG. 3B, or the like) is detected. On the other hand, in the nearby vehicle detecting processing of the third embodiment, in addition to the vehicle ahead 300e, the vehicle behind 300f which is present behind the host vehicle 10 is also detected.

Steps S103 and S104 are the same as Steps S13 and S14 of FIG. 5. That is, in step S103, the ACC section 172 determines whether or not a nearby vehicle 300 is present based on the result of the nearby vehicle detecting processing executed by the external environment recognizing section 170. If a nearby vehicle 300 is present (S103: TRUE), in step S104, the ACC section 172 determines whether or not a plurality of nearby vehicles 300 are present. If a plurality of nearby vehicles 300 are present (S104: TRUE), the procedure proceeds to step S105.

In step S105, the ACC section 172 determines whether or not a plurality of vehicles ahead are present. If a plurality of vehicles ahead are present (S105: TRUE), in Steps S106 and S107, the same processing as the processing of Steps S15 and S16 of FIG. 5 is performed. That is, the target acceleration or deceleration atar is calculated in relation to the vehicles ahead irrespective of the presence or absence of a vehicle behind. If a plurality of vehicles ahead are not present (S105: FALSE), the procedure proceeds to step S108.

In step S108, the ACC section 172 determines whether or not one vehicle ahead is present. If one vehicle ahead is present (S108: TRUE), there is one vehicle ahead and there is one or more than one vehicle behind. In that case, in step S109, the ACC section 172 calculates the target acceleration or deceleration atar with respect to the one vehicle ahead.

If no vehicle ahead is present (S108: FALSE), a plurality of vehicles behind are present. In that case, in step S110, the ACC section 172 calculates the temporary target acceleration or deceleration atarp with respect to each vehicle behind. Specifically, the ACC section 172 calculates the temporary target acceleration or deceleration atarp with respect to each vehicle behind in the same manner as in FIG. 6 of the first embodiment. While ACC of the first embodiment is performed only on the vehicle ahead, ACC of the third embodiment is performed on the vehicle ahead and the vehicle behind.

For this reason, the target inter-vehicle distance Dtar between the host vehicle 10 and each vehicle behind (S31 of FIG. 6) is set as the distance between the rear end of the host vehicle 10 and the front end of each vehicle behind, for example. Moreover, the ACC section 172 sets the target inter-vehicle distance Dtar so that the higher the vehicle speed V of the host vehicle 10, the longer the target inter-vehicle distance Dtar.

Furthermore, when calculating the temporary target acceleration or deceleration atarp based on the deviation ΔD of the actual inter-vehicle distance D from the target inter-vehicle distance Dtar and the relative velocity Vre1 (S34 of FIG. 6), the ACC section 172 calculates the temporary target acceleration or deceleration atarp so that the larger the deviation ΔD than zero (the shorter the actual inter-vehicle distance D than the target inter-vehicle distance Dtar), the larger the target acceleration or deceleration atar without allowing the actual vehicle speed V to exceed the set vehicle speed Vset (the larger the acceleration). Moreover, as the deviation ΔD becomes smaller than zero (the actual inter-vehicle distance D becomes longer than the target inter-vehicle distance Dtar), the ACC section 172 allows the target acceleration or deceleration atar to be reduced (the deceleration to be increased) when the actual vehicle speed V exceeds the set vehicle speed Vset. In other words, the ACC section 172 makes smaller the smallest allowable value of the target acceleration or deceleration atar.

Moreover, as for the relative velocity Vre1 of the host vehicle 10 with respect to the vehicle behind, a direction in which the host vehicle 10 approaches the vehicle behind is assumed to be positive and a direction in which the host vehicle 10 moves away from the vehicle behind is assumed to be negative. The ACC section 172 calculates the temporary target acceleration or deceleration atarp so that the higher the relative velocity Vre1, the larger the target acceleration or deceleration atar (the larger the acceleration) without allowing the actual vehicle speed V to exceed the set vehicle speed Vset.

In step S111, the ACC section 172 selects, as the target acceleration or deceleration atar, the greatest value (a value which suppresses approach to each vehicle behind most significantly) of the values of the temporary target acceleration or deceleration atarp calculated in step S110. It is to be noted that, as described above, the target acceleration or deceleration atar is set so that the actual vehicle speed V does not exceed the set vehicle speed Vset.

Steps S112, S113, S114, and S115 are the same as Steps S17, S18, S19, and S20 of FIG. 5.

### <C-3. Effects of the Third Embodiment>

According to the above-described third embodiment, in addition to or in place of the effects of the first embodiment, the following effects can be obtained.

According to the third embodiment, if the external environment recognizing section 170 (the nearby vehicle detecting unit) detects the vehicle ahead 300e and the vehicle behind 300f (S105 of FIG. 12: TRUE or S108 of FIG. 12: TRUE), the vehicle controlling section 182 (the vehicle controlling unit) uses the temporary target acceleration or deceleration atarp which is set with respect to the vehicle ahead 300e by giving higher priority thereto than the temporary target acceleration or deceleration atarp which is set with respect to the vehicle behind 300f (S107, S109). As a result, even when the vehicle 300e travelling ahead is slower than the host vehicle 10 and the vehicle behind 300f is faster than the host vehicle 10, the temporary target acceleration or deceleration atarp (or the target acceleration or deceleration atar) which is set with respect to the vehicle ahead 300e is preferentially used. This makes it possible to accelerate or decelerate the host vehicle 10 in accordance with a vehicle occupant's perception.

### D. Modified Examples

It goes without saying that the present invention is not limited to the above-described embodiments and can adopt various configurations based on the descriptions of the present specification. For example, the present invention can adopt the following configurations.

### <D-1. Configuration of the Vehicle 10>

The external environment sensor 20 of the first embodiment includes a plurality of vehicle exterior cameras 50 and a plurality of radars 52 (FIG. 1). However, the external environment sensor 20 is not limited thereto from the viewpoint of detecting a nearby vehicle 300, for example.

For instance, when a plurality of cameras 50 that take images of a front area are provided, the radars 52 can be omitted. Alternatively, in addition to or in place of the vehicle exterior cameras 50 and the radars 52, light detection and ranging (LIDAR) may be used. LIDAR emits laser in all directions from the vehicle 10 in a continuous manner, measures the three-dimensional position of a reflecting point based on the reflected waves, and outputs the three-dimensional position as three-dimensional information Ilidar. The same goes for the second and third embodiments.

In the first embodiment, software which is used by the computation unit 152 is recorded on the storage device 154 in advance; however, the software is not limited to such software. For example, the software may be software downloaded from the outside (for instance, an external server with which communication is possible via a public network) or software delivered via the so-called application service provider (ASP) model without downloading. The same goes for the second and third embodiments.

### <D-2. Control>

### [D-2-1. Target Degree of Approach]

In the first embodiment, the acceleration or deceleration of the host vehicle 10 is controlled by using the deviation ΔD of the actual inter-vehicle distance D from the target inter-vehicle distance Dtar (S15 of FIG. 5, S34 of FIG. 6). However, the target degree of approach is not limited thereto from the viewpoint of controlling the acceleration or deceleration of the host vehicle 10 by using the target degree of approach to the nearby vehicle 300, for example. For instance, in place of the deviation ΔD, time-to-collision (TTC) can be used. The same goes for the second and third embodiments.

### [D-2-2. Target Value of Control of the Acceleration or Decleration of the Host Vehicle 10]

In ACC of the first embodiment, the target acceleration or deceleration atar is used as a target value of control of the acceleration or deceleration of the host vehicle 10 (S19 of FIG. 5). However, a target value of control of the acceleration or deceleration of the host vehicle 10, for example, is not limited thereto. For instance, it is also possible to control the acceleration or deceleration of the host vehicle 10 by using the target vehicle speed Vtar. In that case, if a plurality of nearby vehicles 300 (vehicles ahead) are present, the vehicle controlling section 182 calculates a temporary target vehicle speed Vtarp with respect to each nearby vehicle 300. Then, the vehicle controlling section 182 selects, as the target vehicle speed Vtar, a value which suppresses approach to the nearby vehicles 300 most significantly among the values of the temporary target vehicle speed Vtarp.

### [D-2-3. Exclusion Processing]

In the exclusion processing of the second embodiment, the vehicle occupant gives an exclusion command by touching an icon of the nearby vehicle 300 displayed on the touch panel 104 (S74 of FIG. 8). However, a way to give an exclusion command is not limited thereto from the viewpoint of excluding the nearby vehicle 300 recognized by the external environment recognizing section 170 from the calculation based on an instruction provided by the vehicle occupant, for example. For instance, an exclusion command may be given when the set vehicle speed Vset is increased by the ACC SW 100 or an operation of the acceleration pedal 80 by which the amount of operation θap is increased to or above an amount-of-operation threshold value is performed in a predetermined period.

In the second embodiment, the exclusion processing is used (S54 of FIG. 7 and FIG. 8). However, for example, the use of the offset distance Do (FIG. 10) makes it possible to omit the exclusion processing from the second embodiment. Alternatively, it is also possible to perform the exclusion processing in the first or third embodiment.

[D-2-4. Relation to the Nearby Vehicles 300 Present in the Adjacent Lanes 312a and 312c]

In the second embodiment, the offset distance Do is used in relation to the nearby vehicles 300 which are present in the adjacent lanes 312a and 312c (S84 of FIG. 9). However, for example, the exclusion processing makes it possible to omit the use of the offset distance Do from the second embodiment. Alternatively, it is also possible to use the offset distance Do in the first or third embodiment as in the case of the second embodiment.

Alternatively, for example, from the viewpoint of controlling the acceleration or deceleration of the host vehicle 10 based on the relationship with a plurality of nearby vehicles 300, a nearby vehicle 300 of the nearby vehicles 300 (the second vehicle ahead 300b and the like) which are present in the adjacent lanes 312a and 312c, the nearby vehicle 300 on which the calculation of the temporary target vehicle speed Vtarp or the temporary target acceleration or deceleration atarp is performed, may be limited to a nearby vehicle 300 that has started a lane change to the host vehicle lane 312b. That is, the ACC section 172 performs lane change determination processing by which a determination as to whether or not each of the nearby vehicles 300 which are present in the adjacent lanes 312a and 312c has started a lane change to the host vehicle lane 312b is made. Then, the ACC section 172 may start the calculation of the temporary target vehicle speed Vtarp or the temporary target acceleration or deceleration atarp with respect to the nearby vehicle 300, which has started a lane change, in the adjacent lane 312a or 312c. A determination as to whether or not the nearby vehicle 300 has started a lane change can be made by using at least one of the direction of travel of the nearby vehicle 300, the offset distance Do, and the amount of change in the offset distance Do per unit time.

When the lane change determination processing is used, a comparison between the values of the temporary target vehicle speed Vtarp or the temporary target acceleration or deceleration atarp set with respect to the nearby vehicles 300 in the host vehicle lane 312b and the adjacent lanes 312a and 312c may be made only while the nearby vehicle 300 in the adjacent lane 312a or 312c is making a lane change. In that case, a lane change can be judged to have finished if, for example, the lateral movement of the nearby vehicle 300 (the second vehicle ahead 300b or the like) making the lane change is stopped, a first predetermined time has elapsed since the lateral movement ceased, a second predetermined time has elapsed since a comparison between the values of the temporary target vehicle speed Vtarp or the like started, and the host vehicle 10 or the nearby vehicle 300 has moved by a predetermined distance after the lateral movement ceased.

### <D-3. Other>

In the first embodiment, the flows shown in FIGS. 5 and 6 are used. However, for example, the details of the flow (the order of the steps) are not limited to those described above as long as the effects of the present invention can be obtained. For instance, step S32 of FIG. 6 can be performed before step S31. The same goes for the second and third embodiments.

What is claimed is:

1. A travel control device comprising:
a target degree-of-approach setting unit configured to set a target degree of approach to a nearby vehicle detected by a nearby vehicle detecting unit; and
a vehicle controlling unit configured to control, based on the target degree of approach, a host vehicle to follow a vehicle ahead as the nearby vehicle detected by the nearby vehicle detecting unit, wherein
when the nearby vehicle detecting unit detects a plurality of the nearby vehicles, the vehicle controlling unit
sets a temporary target vehicle speed or temporary target acceleration or deceleration with respect to each of the plurality of the nearby vehicles by using the target degree of approach,
selects, as a target vehicle speed or target acceleration or deceleration, a value which suppresses approach to the nearby vehicle most significantly among values of the temporary target vehicle speed or the temporary target acceleration or deceleration, and
controls acceleration or deceleration of the host vehicle based on the target vehicle speed or the target acceleration or deceleration.

2. The travel control device according to claim 1, wherein when a second vehicle traveling ahead in an adjacent lane is making a lane change from the adjacent lane to a travel lane of the host vehicle toward an area between the host vehicle and a first vehicle traveling ahead in the travel lane of the host vehicle while the host vehicle is in follow-on traveling behind the first vehicle ahead, the vehicle controlling unit continues a comparison between the values of the temporary target vehicle speed or the temporary target acceleration or deceleration set with respect to the first vehicle ahead and the second vehicle ahead until the second vehicle travelling ahead has completed a lane change.

3. The travel control device according to claim 1, wherein the vehicle controlling unit changes the temporary target vehicle speed or the temporary target acceleration or deceleration so that the host vehicle is prevented from approaching closer to the nearby vehicle as an offset distance between the host vehicle and the nearby vehicle in a width direction of a road is reduced.

4. The travel control device according to claim 1, wherein the vehicle controlling unit
makes a displaying unit display icons of the plurality of the nearby vehicles which are objects on which the temporary target vehicle speed or the temporary target acceleration or deceleration is to be set,
monitors whether or not an exclusion command, by which any one of the plurality of the nearby vehicles as targets is excluded from the targets, is input to an operating unit by a vehicle occupant, and
excludes the nearby vehicle, which is designated by the exclusion command input via the operating unit, from the targets.

5. The travel control device according to claim 1, wherein when the nearby vehicle detecting unit detects the vehicle travelling ahead and a vehicle travelling behind, the vehicle controlling unit uses the temporary target vehicle speed or the temporary target acceleration or deceleration which is set with respect to the vehicle travelling ahead by giving higher priority thereto than the temporary target vehicle speed or the temporary target acceleration or deceleration which is set with respect to the vehicle travelling behind.

6. A travel control method comprising:
a nearby vehicle detecting step of detecting a nearby vehicle in surrounding areas of a host vehicle;
a target degree-of-approach setting step of setting a target degree of approach to the nearby vehicle; and
a vehicle controlling step of controlling, based on the target degree of approach, the host vehicle to follow a vehicle travelling ahead as the nearby vehicle detected in the nearby vehicle detecting step, wherein
when a plurality of the nearby vehicles are detected in the nearby vehicle detecting step, in the vehicle controlling step,
a temporary target vehicle speed or temporary target acceleration or deceleration with respect to each of the plurality of the nearby vehicles is set by using the target degree of approach,
a value which suppresses approach to the nearby vehicles most significantly among values of the temporary target vehicle speed or the temporary target acceleration or deceleration, is selected as a target vehicle speed or target acceleration or deceleration, and
acceleration or deceleration of the host vehicle is controlled based on the target vehicle speed or the target acceleration or deceleration.
